(19) United States
(12) Patent Application Publication
(10) Pub. No.: US 2020/0160040 A1
(43) Pub. Date: May 21, 2020

(54) THREE-DIMENSIONAL LIVING-BODY FACE DETECTION METHOD, FACE AUTHENTICATION RECOGNITION METHOD, AND APPARATUSES

(71) Applicant: Alibaba Group Holding Limited, George Town (KY)

(72) Inventors: Chenguang MA, Beijing (CN); Liang LI, Beijing (CN)

(73) Assignee: Alibaba Group Holding Limited

(21) Appl. No.: 16/774,037

(22) Filed: Jan. 28, 2020

Related U.S. Application Data
(63) Continuation of application No. 16/509,594, filed on Jul. 12, 2019.

(30) Foreign Application Priority Data
Jul. 16, 2018 (CN) 201810777429.X

(51) Int. Cl. G06K 9/00; G06N 3/04

(52) U.S. Cl. CPC G06K 9/00288; G06N 3/0454; G06K 9/00906; G06K 9/00201

(57) ABSTRACT

Embodiments of this specification relate to a three-dimensional living-body face detection method, a face authentication recognition method, and apparatuses. The three-dimensional living-body face detection method includes: acquiring multiple frames of depth images for a target detection object; pre-aligning the multiple frames of depth images to obtain pre-processed point cloud data; normalizing the point cloud data to obtain a grayscale depth image; and performing living-body detection based on the grayscale depth image and a living-body detection model.

### CROSS-REFERENCE TO RELATED APPLICATIONS

This application is based upon and claims priority to Chinese Patent Application No. 201810777429.X, filed on Jul. 16, 2018, the entire content of all of which is incorporated herein by reference.

### TECHNICAL FIELD

Embodiments of this specification relate to the field of computer technologies, and in particular, to a three-dimensional living-body face detection method, a face authentication recognition method, and apparatuses.

### TECHNICAL BACKGROUND

Currently popular face recognition and detection technologies have been used to improve the security of authentication.

In face recognition systems, the most common cheating manner is counterfeiting attacks, in which an imposter intrudes a face recognition system with a counterfeit feature of the same representation form. At present, common counterfeiting attacks mainly include photos, videos, three-dimensional models, and so on.

Currently, living-body detection technologies are mainly used to defend against similar attacks, in which instructions are delivered to instruct completion of specific living-body actions such as blinking, turning the head, opening the mouth, or other physiological behaviors, thereby determining whether these living-body actions are completed by a living body. However, these living-body detection methods cannot achieve desirable detection performance, which affects the living-body detection results, thereby affecting the accuracy of authentication recognition.

### SUMMARY

Embodiments of this specification provide a three-dimensional living-body face detection method, a face authentication recognition method, and apparatuses.

In a first aspect, a three-dimensional living-body face detection method includes: acquiring multiple frames of depth images for a target detection object; pre-aligning the multiple frames of depth images to obtain pre-processed point cloud data; normalizing the point cloud data to obtain a grayscale depth image; and performing living-body detection based on the grayscale depth image and a living-body detection model.

In a second aspect, a face authentication recognition method includes: acquiring multiple frames of depth images for a target detection object; pre-aligning the multiple frames of depth images to obtain pre-processed point cloud data; normalizing the point cloud data to obtain a grayscale depth image; performing living-body detection based on the grayscale depth image and a living-body detection model; and determining whether a face authentication recognition succeeds according to a result of the living-body detection.

In a third aspect, a three-dimensional face detection apparatus includes: an acquisition module configured to acquire multiple frames of depth images for a target detection object; a first pre-processing module configured to pre-align the multiple frames of depth images to obtain pre-processed point cloud data; a normalization module configured to normalize the point cloud data to obtain a grayscale depth image; and a detection module configured to perform living-body detection based on the grayscale depth image and a living-body detection model.

In a fourth aspect, a face authentication recognition apparatus includes: an acquisition module configured to acquire multiple frames of depth images for a target detection object; a first pre-processing module configured to pre-align the multiple frames of depth images to obtain pre-processed point cloud data; a normalization module configured to normalize the point cloud data to obtain a grayscale depth image; a detection module configured to perform living-body detection based on the grayscale depth image and a living-body detection model; and a recognition module configured to determine whether a face authentication recognition succeeds according to a result of the living-body detection.

In a fifth aspect, an electronic device includes: a memory storing a computer program; and a processor, wherein the processor is configured to execute the computer program to: acquire multiple frames of depth images for a target detection object; pre-align the multiple frames of depth images to obtain pre-processed point cloud data; normalize the point cloud data to obtain a grayscale depth image; and perform living-body detection based on the grayscale depth image and a living-body detection model.

In a sixth aspect, an electronic device includes: a memory storing a computer program; and a processor, wherein the processor is configured to execute the computer program to: acquire multiple frames of depth images for a target detection object; pre-align the multiple frames of depth images to obtain pre-processed point cloud data; normalize the point cloud data to obtain a grayscale depth image; perform living-body detection based on the grayscale depth image and a living-body detection model; and determine whether a face authentication recognition succeeds according to a result of the living-body detection.

In a seventh aspect, a computer-readable storage medium stores one or more programs, wherein when executed by a processor of an electronic device, the one or more programs cause the electronic device to perform: acquiring multiple frames of depth images for a target detection object; pre-aligning the multiple frames of depth images to obtain pre-processed point cloud data; normalizing the point cloud data to obtain a grayscale depth image; and performing living-body detection based on the grayscale depth image and a living-body detection model.

In an eighth aspect, a computer-readable storage medium stores one or more programs, wherein when executed by a processor of an electronic device, the one or more programs cause the electronic device to perform: acquiring multiple frames of depth images for a target detection object; pre-aligning the multiple frames of depth images to obtain pre-processed point cloud data; normalizing the point cloud data to obtain a grayscale depth image; performing living-body detection based on the grayscale depth image and a living-body detection model; and determining whether the authentication recognition succeeds according to the living-body detection result.

At least one of the above technical solutions adopted in the embodiments of this specification can achieve the following beneficial effects.

With the above technical solution, multiple frames of depth images for a target detection object are acquired to ensure the overall performance of an image input as detection data; the multiple frames of depth images are pre-aligned and the point cloud data is normalized to obtain a grayscale depth image, which can ensure the integrity and accuracy of the grayscale depth image and compensate for the image quality problem; and finally, the living-body detection is performed based on the grayscale depth image and a living-body detection model, thereby improving the accuracy of the living-body detection. Then, more effective security verification or attack defense can be implemented based on the result of the living-body detection.

### BRIEF DESCRIPTION OF THE DRAWINGS

The accompanying drawings are incorporated into the description and constitute a part of the present description, and together with the description, illustrate embodiments and explain the principle disclosed in the specification.

FIG. 1a is a flow chart of a three-dimensional living-body face detection method according to an embodiment.

FIG. 1b is a flow chart of a three-dimensional living-body face detection method according to an embodiment.

FIG. 2a is a flow chart of a living-body detection model generation method according to an embodiment.

FIG. 2b is a flow chart of a living-body detection model generation method according to an embodiment.

FIG. 3 is a schematic diagram of a human living-body face detection method according to an embodiment.

FIG. 4 is a flow chart of a face authentication recognition method according to an embodiment.

FIG. 5 is a schematic diagram of an electronic device according to an embodiment.

FIG. 6a is a schematic diagram of a three-dimensional living-body face detection apparatus according to an embodiment.

FIG. 6b is a schematic diagram of a three-dimensional living-body face detection apparatus according to an embodiment.

FIG. 6c is a schematic diagram of a three-dimensional living-body face detection apparatus according to an embodiment.

FIG. 6d is a schematic diagram of a three-dimensional living-body face detection apparatus according to an embodiment.

FIG. 7 is a schematic diagram of a face authentication recognition apparatus according to an embodiment.

### DETAILED DESCRIPTION

Embodiments of the specification will be described in detail below with reference to the accompanying drawings. The described embodiments are only examples rather than all the embodiments consistent with this specification. All other embodiments obtained by those of ordinary skill in the art based on the embodiments of this specification without creative efforts fall within the protection scope of the embodiments of this specification.

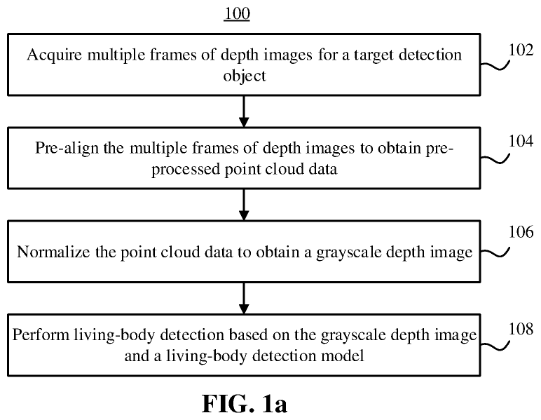

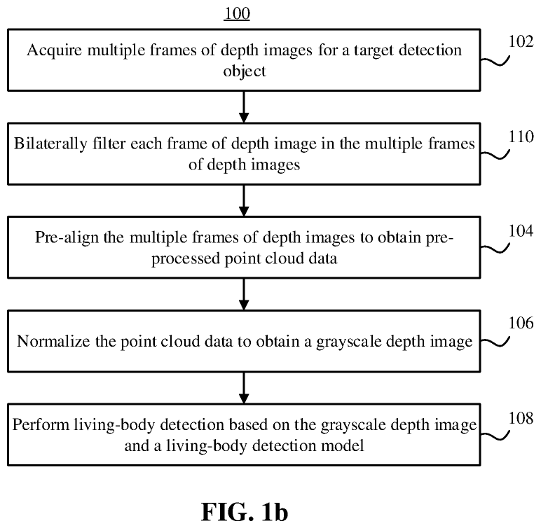

FIG. 1a is a flow chart of a three-dimensional living-body face detection method 100 according to an embodiment. The method 100 may be executed by a three-dimensional living-body face detection apparatus or a mobile terminal installed with the three-dimensional living-body face detection apparatus. The method 100 may include the following steps.

In step 102, multiple frames of depth images for a target detection object are acquired.

In the embodiment, the three-dimensional living-body face detection is mainly three-dimensional living-body face detection for a human. It is determined according to analysis on a three-dimensional human face image whether a target detection object is a living body, i.e., whether it is the person corresponding to the target detection object in the image. The target detection object of the three-dimensional living-body face detection is not limited to a human, but can be an animal having a recognizable face, which is not limited in the embodiment of this specification.

The living-body detection can determine whether a current operator is a living human or a non-human such as a picture, a video, a mask, or the like. The living-body detection can be applied to scenarios using face swiping verification such as clock in and out and face swiping payment.

The multiple frames of depth images refer to images acquired for a face region of the target detection object by means of photographing, infrared, or the like, and specifically depth images that can be acquired by a depth camera that measures a distance between an object (the target detection object) and the camera. The depth camera may include: a depth camera based on a structured light imaging technology, or a depth camera based on a light time-of-flight imaging technology. Further, while the depth image is acquired, a color image for the target detection object, that is, an RGB image, is also acquired. Since color images are generally acquired during image acquisition, it may be set by default that a color image is also acquired while a depth image is acquired.

In some embodiments, the depth camera based on the structured light imaging technology may be sensitive to illumination and may not be used in an outdoor scene with strong light. Accordingly, an active binocular depth camera may be used to acquire a depth image of the target detection object.

In the embodiment, the multiple frames of depth images may be acquired from a depth camera device (such as various types of depth cameras mentioned above) externally mounted on the three-dimensional living-body face detection apparatus, that is, these depth images are acquired by the depth camera and transmitted to the three-dimensional living-body face detection apparatus; or acquired from a depth camera device built in the three-dimensional living-body face detection apparatus, that is, the depth images are acquired by the three-dimensional living-body face detection apparatus through a built-in depth camera. This is not limited in this specification.

In step 104, the multiple frames of depth images are pre-aligned to obtain pre-processed point cloud data.

In some embodiments, the depth images acquired in step 102 are acquired based on depth cameras, and may be incomplete, limited in accuracy, etc. Therefore, the depth images may be pre-processed before use.

The multiple frames of depth images may be pre-aligned, thereby effectively compensating for the acquisition quality problem of the depth camera, having better robustness to subsequent three-dimensional living-body face detection, and improving the overall detection accuracy.

In step 106, the point cloud data is normalized to obtain a grayscale depth image.

In the embodiment, the pre-alignment of the depth images can be regarded as a feature extraction process. After the feature extraction and the pre-alignment, the point cloud data may be normalized to a grayscale depth image that can be used by the subsequent algorithm. Thus, the integrity and accuracy of the image are further improved.

In step 108, living-body detection is performed based on the grayscale depth image and a living-body detection model.

In the embodiment, when living-body detection is performed on a target, depth images may vary for a living target detection object and a non-living target detection object. Taking the human living-body face detection as an example, if the target detection object is a face photo, a video, a three-dimensional model, or the like, instead of a living human face, a distinction is made at the time of detection. Therefore, it is determined whether the target detection object is a living body or a non-living body by detecting the acquired depth images of the target detection object.

With the above technical solution, multiple frames of depth images for a target detection object are acquired to ensure the overall performance of an image input as detection data; the multiple frames of depth images are pre-aligned and the point cloud data is normalized to obtain a grayscale depth image, which can ensure the integrity and accuracy of the grayscale depth image and compensate for the image quality problem; and finally, the living-body detection is performed based on the grayscale depth image and a living-body detection model, thereby improving the accuracy of the living-body detection. Then, more effective security verification or attack defense can be implemented based on the detection results.

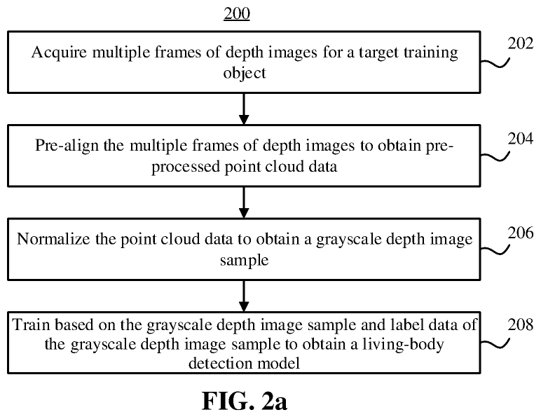

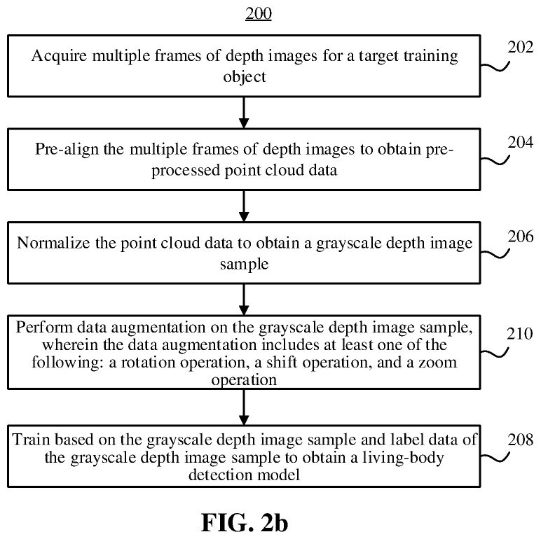

The living-body detection model may be a preset normal living-body detection model. FIG. 2a is a flow chart of a method 200 for obtaining the living-body detection model, according to an embodiment.

In step 202, multiple frames of depth images for a target training object are acquired.

The multiple frames of depth images for the target training object in this step may be a historical depth image extracted from an existing depth image database or other storage spaces. Unlike the depth image in step 102, the type of the target training object (living body or non-living body) is known.

In step 204, the multiple frames of depth images are pre-aligned to obtain pre-processed point cloud data. The specific implementation of the step 204 similar to step 104.

In step 206, the point cloud data is normalized to obtain a grayscale depth image sample.

The point cloud data obtained after the pre-alignment based on the above step 204 is normalized to obtain a gray-scale depth image sample. As the sample, the depth image subjected to the pre-alignment and the normalization is mainly used as data of a known type that is input to a training model subsequently. The normalization here is the same as the implementation of step 106.

In step 208, training is performed based on the grayscale depth image sample and label data of the grayscale depth image sample to obtain the living-body detection model.

Label data of the grayscale depth image sample may be a type label of the target training object. In the embodiment, the type label may be set to be: living body or non-living body.

In an embodiment, a convolutional neural network (CNN) structure may be selected as a training model, and the CNN structure mainly includes a convolution layer and a pooling layer. A construction process thereof may include: convolution, activation, pooling, full connection, and the like. The CNN structure can perform binary training on the input image data and the label of the training object, thereby obtaining a classifier. For example, the grayscale depth image samples A1 (label data: living body), B1 (label data: living body), A2 (label data: non-living body), B2 (label data: living body), A3 (label data: living body), B3 (label data: non-living body), etc. after normalization are used as data input to the training model, i.e., the CNN structure. After that, the CNN structure performs model training according to the input data, and finally obtains a classifier, which can accurately identify whether the target detection object corresponding to the input data is a living body and output the detection result.

It should be noted that in the actual model training process, the quantity of data (grayscale depth image samples) input to the training model can be enough to support the training model for effective training. This embodiment is for only for illustration.

The classifier mentioned above can be understood as a living-body detection model obtained by training. As there are only two types (living or non-living) of the labels (i.e., the label data) input during training in the embodiment, the classifier can be a binary classifier.

According to the living-body detection model obtained in the above FIG. 2a, the CNN model is trained based on the grayscale depth image sample after the pre-processing and the normalization used as the input data. Therefore, a more accurate living-body detection model can be obtained and, further, the living-body detection based on the living-body detection model is more accurate.

In an embodiment, step 104 may include: roughly aligning the multiple frames of depth images based on three-dimensional key facial points; and finely aligning the roughly aligned depth images based on an iterative closest point (ICP) algorithm to obtain the point cloud data. Thus, step 104 may mainly include rough alignment and fine alignment.

The multiple frames of depth images are roughly aligned based on three-dimensional key facial points. In an embodiment, an RGB image detection mode may be used to determine the face key points in the depth image, and then the determined face key points are subjected to point cloud rough-alignment. The face key points can be five key points in the human face including the two corners of eyes, the tip of the nose, and the two corners of the mouth. With the point cloud rough-alignment, the multiple frames of depth images are only roughly registered to ensure that the depth image is substantially aligned.

The point cloud data is obtained by finely aligning the depth images after the rough alignment based on the ICP algorithm. In an embodiment, the depth images processed by the rough alignment may be used as the initialization of the ICP algorithm, and then the iterative process of the ICP algorithm is used to perform fine alignment. In the embodiment, in the process of the ICP algorithm selecting key points, random sample consensus (RANSAC) point selection is performed with reference to position information of five key points of the human face including the two corners of eyes, the tip of the nose, and the two corners of the mouth. At the same time, the number of iterations is limited so that the iterations are not excessive, thereby ensuring the processing speed of the system.

In an embodiment, shown in FIG. 1b, before performing step 104, the method 100 further includes step 110: bilaterally filtering each frame of depth image in the multiple frames of depth images.

In the embodiment, the multiple frames of depth images are acquired, and each frame of depth image may have an image quality problem. Therefore, each frame of depth image in the multiple frames of depth images may be bilaterally filtered, thereby improving the integrity of each frame of depth image.

In an embodiment, each frame of depth image can be bilaterally filtered with reference to the following formula:

$$g ( i , j ) = \frac{{\sum }_{k , l} f ( k , l ) ω ( i , j , k , l )}{{\sum }_{k , l} ω ( i , j , k , l )} \qquad ( 1 )$$

wherein g (i, j) represents a depth value of a pixel (i, j) in the depth image after the bilateral filtering, f (k,l) is a depth value of a pixel (k,l) in the depth image before the bilateral filtering, and ω(i,j,k,l) is a weight value of the bilateral filtering.

Further, the weight value ω(i,j,k,l) of the bilateral filtering can be calculated by the following formula:

$$ω ( i , j , k , l ) = exp ( - \frac{{( i - k )}^{2} + {( j - l )}^{2}}{2 {σ}_{d}^{2}} - \frac{{‖ {f}_{c} ( i , j ) - {f}_{c} ( k , l ) ‖}^{2}}{2 {σ}_{r}^{2}} ) \qquad ( 2 )$$

wherein f_{c}(i, j) represents a color value of a pixel (i, j) in the color image, f_{c}(k,l) represents a color value of a pixel (k,l) in the color image, σ_{d}² is a filtering parameter corresponding to the depth image, and σᵣ² is a filtering parameter corresponding to the color image.

In an embodiment, in step 106, when the point cloud data is normalized to obtain a grayscale depth image, the method 100 may be implemented as follows.

In step 1, an average depth of the face region is determined according to three-dimensional key facial points in the point cloud data.

Taking the three-dimensional face being a human face as an example, the average depth of the human face region is calculated by average weighting or the like according to the five key points of the human face.

In step 2, the face region is segmented, and a foreground and a background in the point cloud data are deleted.

Image segmentation is performed on the face region, for example, key points such as nose, mouth, and eyes are obtained by segmentation, and then the point cloud data corresponding to a foreground image and the point cloud data corresponding to a background image other than the human face in the point cloud data are deleted, thereby eliminating the interference of the foreground image and the background image with the point cloud data.

In step 3, the point cloud data from which the foreground and background have been deleted is normalized to preset value ranges before and after the average depth that take the average depth as the reference to obtain a grayscale depth image.

The depth values of the face region having the interference from the foreground and the background excluded are normalized to preset value ranges before and after the average depth determined in step 1 that take the average depth as the reference, wherein the preset value ranges before and after the average depth that take the average depth as the reference refer to a depth range between the average depth and a front preset value and a depth range between the average depth and a rear preset value. The front refers to the side of a human face that faces the depth camera, and the rear refers to the side of a human face that opposes the depth camera.

For example, if the average depth of the face region previously determined is D1 and the preset value is D2, the depth value range of the face region normalized is [D1−D2, D1+D2]. Considering that the thickness of the contour of the human face is limited and is substantially within a certain range, the preset value may be set to any value between 30 mm and 50 mm. In an embodiment, the preset value is set to 40 mm.

In the embodiment, the normalization involved in the above step 106 can be applied to the normalization of the model training shown in FIG. 2a.

In an embodiment, referring to FIG. 2b, before step 208 is performed, the method 200 further includes step 210: performing data augmentation on the grayscale depth image sample, wherein the data augmentation includes at least one of the following: a rotation operation, a shift operation, and a zoom operation.

By the above data augmentation, the quantity of the grayscale depth image samples (living body, non-living body) can be increased, the robustness of model training can be improved, and the accuracy of living-body detection can be further improved. During the augmentation, the rotation, shift, and zoom operations may be respectively performed according to three-dimensional data information of the grayscale depth image sample.

In an embodiment, in order to improve the robustness of model training and subsequent living-body detection, the living-body detection model is a model obtained by training based on a convolutional neural network structure.

In the three-dimensional living-body face detection method 100, the three-dimensional face is, for example, a human face, and the training model is, for example, a CNN model.

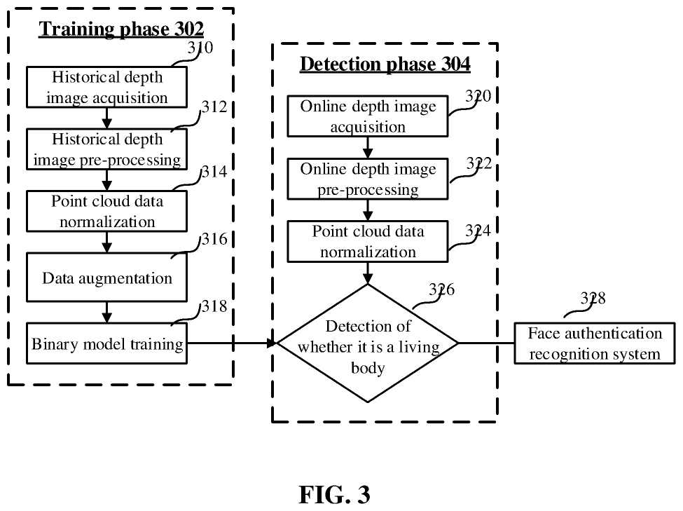

FIG. 3 is a schematic diagram of training of a living-body detection model and living-body face detection according to an embodiment. Here, a training phase 302 may include historical depth image acquisition 310, historical depth image pre-processing 312, point cloud data normalization 314, data augmentation 316, and binary model training 318. A detection phase 304 may include online depth image acquisition 320, online depth image pre-processing 324, point cloud data normalization 326, detection of whether it is a living body based on a binary model (328), or the like. The training phase 302 and the detection phase 304 may also include other processes, which are not shown in FIG. 3.

It should be understood that the binary model in the embodiment may be the living-body detection model shown in FIG. 1a. In some embodiments, the operations of the training phase 302 and the detection phase 304 may be performed by a mobile terminal having a depth image acquisition function or another terminal device. In the following, for example, the operations are performed by a mobile terminal. Specifically, the process shown in FIG. 3 mainly includes the following.

(1) Historical Depth Image Acquisition 310

The mobile terminal acquires historical depth images. Some of these historical depth images are acquired by a depth camera for a living human face, and some are acquired by the depth camera for a non-living (such as a picture and a video) human face image. The historical depth images may be acquired based on an active binocular depth camera and stored as historical depth images in a historical database. The mobile terminal triggers the acquisition of historical depth images from the historical database when model training and/or living-body detection are/is required.

In the embodiment, the historical depth images are the multiple frames of depth images for the target training object described in FIG. 2a. When a historical depth image is acquired, a label corresponding to the historical depth image (i.e., the label data) is also acquired, and the label is used to indicate that a target training object corresponding to the historical depth image is a living body or a non-living body.

(2) Historical Depth Image Pre-Processing 312

After the completion of the historical depth image acquisition, each single-frame depth image in the historical depth images can be bilaterally filtered, then the multiple frames of depth images after bilateral filtering are roughly aligned according to the human face key points, and finally the ICP algorithm is used to finely align the results after the rough alignment, thus implementing accurate registration of the point cloud data. Therefore, more complete and accurate training data can be obtained. The specific implementation of the operations such as bilateral filtering, rough alignment of the human face key points, and fine alignment by the ICP algorithm can be obtained with reference to the related description of the foregoing embodiments, and details are omitted here.

(3) Point Cloud Data Normalization 314

In order to obtain more accurate training data, the registered point cloud data can also be normalized into a grayscale depth image for subsequent use. Firstly, the human face key points and the depth image D are detected according to the human face RGB image, and the average depth df of the face region is calculated. The df can be a numerical value in mm. Secondly, image segmentation is performed on the face region to exclude the interference from the foreground and the background. For example, only all point clouds with depth values in the range of df−40 mm to df+40 mm are reserved as the point cloud P{(x,y,z)|df+40>z>df−40} of the human face. Finally, the depth values of the face region having the interference from the foreground and the background excluded are normalized to a range of 40 mm before and after the average depth (this can be a value range at this time).

(4) Data Augmentation 316

Considering that the quantity of acquired historical depth images may be limited, the normalized grayscale depth image may be augmented to increase the quantity of input data required for model training. The augmentation may be implemented as at least one of a rotation operation, a shift operation, and a zoom operation.

For example, assuming that the normalized grayscale depth images are M1, M2, and M3, the grayscale depth images after the rotation operation are M1(x), M2(x), and M3(x), the grayscale depth images after the shift operation are M1(p), M2(p), and M3(p), and the grayscale depth images after the zoom operation are M1(s), M2(s), and M3(s). As such, the original three grayscale depth images are augmented into twelve grayscale depth images, thereby increasing the input data of living body and non-living body and improving the robustness of model training. At the same time, the detection performance of subsequent living-body detection can further be improved.

It should be understood that the number of the normalized grayscale depth images described above is only an example, and is not limited to three. The specific acquisition quantity may be set as required.

(5) Binary Model Training 318

In the model training, the depth images obtained in step 310 may be used as training data, or the depth images obtained by the pre-processing in step 312 may be used as training data, or the grayscale depth images obtained by the normalization in step 314 may be used as training data, or the grayscale depth images obtained by the augmentation in step 316 may be used as the training data. The living-body detection model trained by inputting the grayscale depth images obtained by the augmentation in step 316 as the training data to the CNN model may be most accurate.

After the normalized grayscale depth images are processed by data augmentation, the CNN structure can be used to extract image features from the augmented grayscale depth images, and then model training is performed based on the extracted image features and the CNN model.

During training, the training data also includes a label of the grayscale depth image, which may be labeled as “living body” or “non-living body” in the embodiment. As such, after the training is completed, a binary model that can output “living body” or “non-living body” according to the input data can be obtained.

(6) Online Depth Image Acquisition 320

Specific implementation of step 320 can be obtained with reference to the acquisition process in step 310.

(7) Online Depth Image Pre-Processing 322

Specific implementation of step 322 can be obtained with reference to the pre-processing process of step 312.

(8) Point Cloud Data Normalization 324

Specific implementation of step 324 can be obtained with reference to the normalization process of step 314.

(9) Detection of Whether it is a Living Body Based on the Binary Model (326)

In the embodiment, the online depth images acquired in step 320 may be used as an input of the binary model, or the online depth images pre-processed in step 322 may be used as an input of the binary model, or the online grayscale depth images normalized in step 324 may be used as an input of the binary model to detect whether the target detection target is a living body.

In the embodiment, the processing manner of inputting the data of the detection model in the detection phase 304 may be the same as the processing manner of inputting the data of the training model in the training phase 302. For example, if the binary model is obtained by training based on the acquired historical depth images, the online depth images acquired in step 320 are used as an input of the binary model for detection.

In the embodiment, in order to ensure the accuracy of the living-body detection, a binary model obtained by training based on the augmented grayscale depth images may be selected, the online grayscale depth image normalized in step 324 is selected as an input, and the binary model can output a detection result of “living body” or “non-living body” based on the input data.

(10) Output the Detection Result to a Living-Body Detection Apparatus (328)

The test result can be obtained based on the binary model.

At this time, the detection result can be fed back to a living-body detection system so that the living-body detection system performs a corresponding operation. For example, in a payment scenario, if the detection result is “living body,” the detection result is fed back to a payment system, so that the payment system performs payment; if the detection result is “non-living body,” the detection result is fed back to the payment system, so that the payment system refuses to perform the payment. Thus, the authentication security can be improved by a more accurate living-body detection method.

The specific embodiments have been described above. In some cases, the actions or steps recited in this specification can be performed in an order different from that in the embodiments and the desired results can still be achieved. In addition, the processes depicted in the accompanying drawings are not necessarily required to be in the shown particular order or successive order to achieve the expected results. In some implementation manners, multitasking and parallel processing are also possible or may be advantageous.

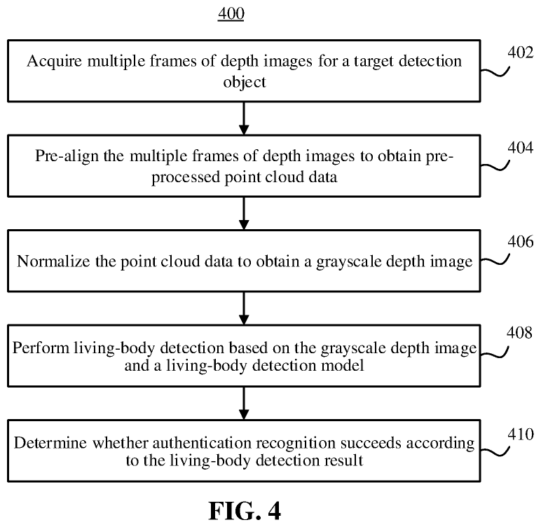

FIG. 4 is a flow chart of a face authentication recognition method 400 according to an embodiment. The method 400 may be performed by a face authentication recognition apparatus or a mobile terminal provided with a face authentication recognition apparatus.

The face authentication recognition method 400 may include the following steps.

In step 402, multiple frames of depth images for a target detection object are acquired.

Specific implementation of step 402 is similar to step 102.

In step 404, the multiple frames of depth images are pre-aligned to obtain pre-processed point cloud data.

Specific implementation of step 404 is similar to step 104.

In step 406, the point cloud data is normalized to obtain a grayscale depth image.

Specific implementation of step 406 is similar to step 106.

In step 408, living-body detection is performed based on the grayscale depth image and a living-body detection model.

Specific implementation of step 408 is similar to step 108.

In step 410, it is determined whether the authentication recognition succeeds according to the living-body detection result.

In the embodiment, the detection result of step 408, living body or non-living body, may be transmitted to an authentication recognition system, so that the authentication recognition system determines whether the authentication succeeds. For example, if the detection result is a living body, the authentication succeeds; and if the detection result is a non-living body, the authentication fails.

With the above technical solution, multiple frames of depth images for a target detection object are acquired to ensure the overall performance of an image input as detection data; the multiple frames of depth images are pre-aligned and the point cloud data is normalized to obtain a grayscale depth image, which can ensure the integrity and accuracy of the grayscale depth image and compensate for the image quality problem; and finally, the living-body detection is performed based on the grayscale depth image and a living-body detection model, thereby improving the accuracy of the living-body detection. Then, more effective security verification or attack defense can be implemented based on the detection results.

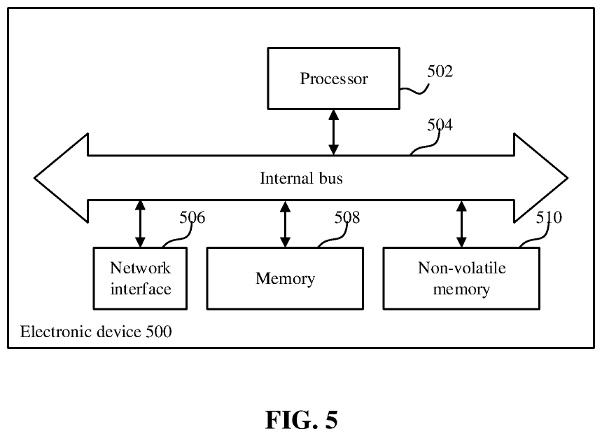

FIG. 5 is a schematic diagram of an electronic device 500 according to an embodiment. Referring to FIG. 5, the electronic device 500 includes a processor 502 and optionally further includes an internal bus 504, a network interface 506, and a memory. The memory may include a memory 508 such as a high-speed Random-Access Memory (RAM), or may further include a non-volatile memory 510 such as at least one magnetic disk memory. The electronic device 500 may further include hardware required by other services.

The processor 502, the network interface 506, and the memory 508 and 510 may be interconnected through the internal bus 504, and the internal bus 504 may be an Industry Standard Architecture (ISA) bus, a Peripheral Component Interconnect (PCI) bus, an Extended Industry Standard Architecture (EISA) bus, or the like. The internal bus 504 may be an address bus, a data bus, a control bus, and the like. For ease of representation, only one double-sided arrow is shown in FIG. 5, but it does not mean that there is only one bus or one type of bus.

Each of the memory 508 and the non-volatile memory 510 is configured to store a program. Specifically, the program may include program codes including a computer operation instruction. The memory 508 and the non-volatile memory 510 may provide an instruction and data to the processor 502.

The processor 502 reads, from the non-volatile memory 510, the corresponding computer program into the memory 508 and runs the computer program, thus forming a three-dimensional face detection apparatus at the logic level. The processor 502 executes the program stored in the memory 508, and is specifically configured to perform the following operations: acquiring multiple frames of depth images for a target detection object; pre-aligning the multiple frames of depth images to obtain pre-processed point cloud data; normalizing the point cloud data to obtain a grayscale depth image; and performing living-body detection based on the grayscale depth image and a living-body detection model.

In some embodiments, the processor 502 performs the following operations: acquiring multiple frames of depth images for a target detection object; pre-aligning the multiple frames of depth images to obtain pre-processed point cloud data; normalizing the point cloud data to obtain a grayscale depth image; performing living-body detection based on the grayscale depth image and a living-body detection model; and determining whether the authentication recognition succeeds according to the living-body detection result.

The three-dimensional living-body face detection methods illustrated in FIG. 1a to FIG. 3 or the face authentication recognition method illustrated in FIG. 4 can be applied to the processor or implemented by the processor. The processor may be an integrated circuit chip having a signal processing capability. In the process of implementation, various steps of the above methods may be completed by an integrated logic circuit of hardware in the processor or an instruction in the form of software. The processor may be a general-purpose processor, including a Central Processing Unit (CPU), a Network Processor (NP), etc.; or may be a Digital Signal Processor (DSP), an Application Specific Integrated Circuit (ASIC), a Field-Programmable Gate Array (FPGA) or another programmable logic device, discrete gate or transistor logic device, or discrete hardware component. The methods, steps, and logical block diagrams disclosed in the embodiments of this specification can be implemented or performed. The general-purpose processor may be a microprocessor, or the processor may be any conventional processor or the like. The steps of the method disclosed in the embodiments of this specification may be directly performed by a hardware decoding processor, or may be performed by a combination of hardware and software modules in the decoding processor. The software module can be located in a storage medium mature in the field, such as a random-access memory, a flash memory, a read-only memory, a programmable read-only memory or electrically erasable programmable memory, a register, and the like. The storage medium is located in the memory, and the processor reads the information in the memory and implements the steps of the above methods in combination with its hardware.

The electronic device can also perform the methods of FIG. 1a to FIG. 3, implement the functions of the three-dimensional living-body face detection apparatus in the embodiments shown in FIG. 1a to FIG. 3, perform the method in FIG. 4, and implement the functions of the face authentication recognition apparatus in the embodiment shown in FIG. 4, which will not be elaborated here.

In addition to the software implementation, the electronic device in the embodiment does not exclude other implementation manners, such as a logic device or a combination of software and hardware, etc. In other words, the above described processing flow is not limited to being executed by various logic units and can also be executed by hardware or logic devices.

A computer-readable storage medium storing one or more programs is further provided in an embodiment, wherein when executed by a server including multiple applications, the one or more programs cause the server to perform the following operations: acquiring multiple frames of depth images for a target detection object; pre-aligning the multiple frames of depth images to obtain pre-processed point cloud data; normalizing the point cloud data to obtain a grayscale depth image; and performing living-body detection based on the grayscale depth image and a living-body detection model.

A computer-readable storage medium storing one or more programs is further provided in an embodiment, wherein when executed by a server including multiple applications, the one or more programs cause the server to perform the following operations: acquiring multiple frames of depth images for a target detection object; pre-aligning the multiple frames of depth images to obtain pre-processed point cloud data; normalizing the point cloud data to obtain a grayscale depth image; performing living-body detection based on the grayscale depth image and a living-body detection model; and determining whether the authentication recognition succeeds according to the living-body detection result.

The computer-readable storage medium is, for example, a Read-Only Memory (ROM), a Random Access Memory (RAM), a magnetic disk, an optical disc, or the like.

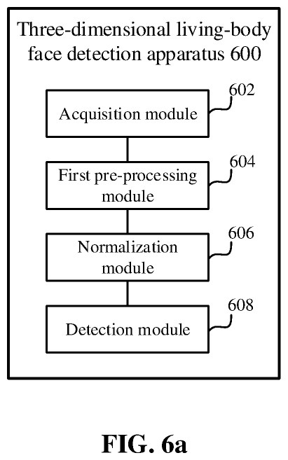

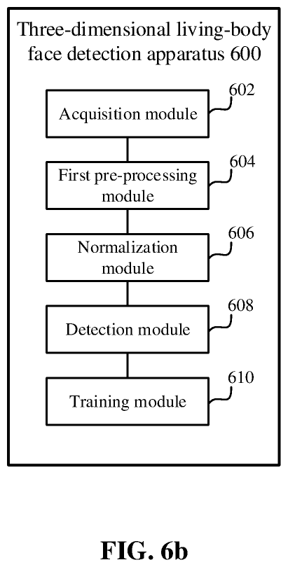

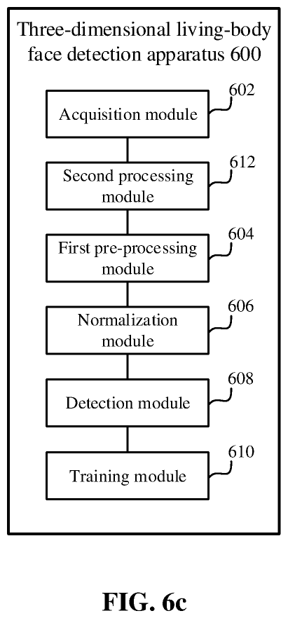

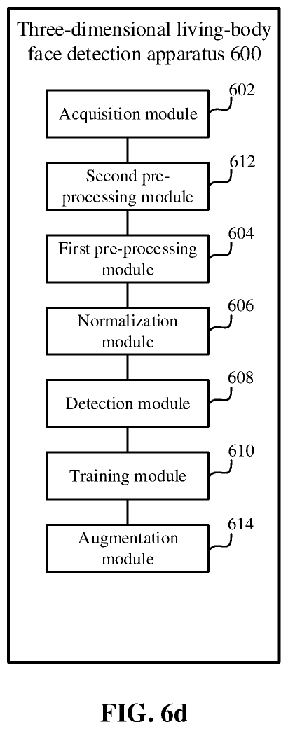

FIG. 6a is a schematic diagram of a three-dimensional living-body face detection apparatus 600 according to an embodiment. The apparatus 600 includes: an acquisition module 602 configured to acquire multiple frames of depth images for a target detection object; a first pre-processing module 604 configured to pre-align the multiple frames of depth images to obtain pre-processed point cloud data; a normalization module 606 configured to normalize the point cloud data to obtain a grayscale depth image; and a detection module 608 configured to perform living-body detection based on the grayscale depth image and a living-body detection model.

With the above technical solution, multiple frames of depth images for a target detection object are acquired to ensure the overall performance of an image input as detection data; the multiple frames of depth images are pre-aligned and the point cloud data is normalized to obtain a grayscale depth image, which can ensure the integrity and accuracy of the grayscale depth image and compensate for the image quality problem; and finally, the living-body detection is performed based on the grayscale depth image and a living-body detection model, thereby improving the accuracy of the living-body detection. Then, more effective security verification or attack defense can be implemented based on the detection results.

In an embodiment, when the living-body detection model is obtained, the acquisition module 602 is configured to acquire multiple frames of depth images for a target detection object; the first pre-processing module 604 is configured to pre-align the multiple frames of depth images to obtain pre-processed point cloud data; and the normalization module 606 is configured to normalize the point cloud data to obtain a grayscale depth image sample.

Moreover, referring to FIG. 6b, the apparatus 600 may further include a training module 610 configured to train based on the grayscale depth image sample and label data of the grayscale depth image sample to obtain the living-body detection model.

In an embodiment, the first pre-processing module 604 is configured to: roughly align the multiple frames of depth images based on three-dimensional key facial points; and finely align the roughly aligned depth images based on an ICP algorithm to obtain the point cloud data.

In an embodiment, shown in FIG. 6c, the three-dimensional living-body face detection apparatus 600 further includes a second pre-processing module 612 configured to bilaterally filter each frame of depth image in the multiple frames of depth images.

In an embodiment the normalization module 604 is configured to: determine an average depth of the face region according to three-dimensional key facial points in the point cloud data; segment the face region, and delete a foreground and a background in the point cloud data; and normalize the point cloud data from which the foreground and background have been deleted to preset value ranges before and after the average depth that take the average depth as the reference to obtain the grayscale depth image.

In an embodiment, the preset value ranges from 30 mm to 50 mm.

In an embodiment, shown in FIG. 6d, the three-dimensional living-body face detection apparatus 600 further includes an augmentation module 614 configured to perform data augmentation on the grayscale depth image sample, wherein the data augmentation comprises at least one of the following: a rotation operation, a shift operation, and a zoom operation.

In an embodiment, the living-body detection model is a model obtained by training based on a convolutional neural network structure.

In an embodiment, the multiple frames of depth images are acquired based on an active binocular depth camera.

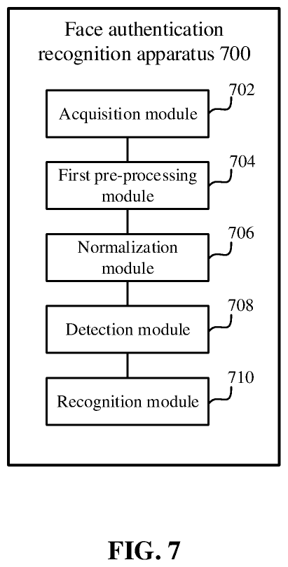

FIG. 7 is a schematic diagram of a face authentication recognition apparatus 700 according to an embodiment. The apparatus 700 includes: an acquisition module 702 configured to acquire multiple frames of depth images for a target detection object; a first pre-processing module 704 configured to pre-align the multiple frames of depth images to obtain pre-processed point cloud data; a normalization module 706 configured to normalize the point cloud data to obtain a grayscale depth image; a detection module 708 configured to perform living-body detection based on the grayscale depth image and a living-body detection model; and a recognition module 710 configured to determine whether the authentication recognition succeeds according to the living-body detection result.

With the above technical solution, multiple frames of depth images for a target detection object are acquired to ensure the overall performance of an image input as detection data; the multiple frames of depth images are pre-aligned and the point cloud data is normalized to obtain a grayscale depth image, which can ensure the integrity and accuracy of the grayscale depth image and compensate for the image quality problem; and finally, the living-body detection is performed based on the grayscale depth image and a living-body detection model, thereby improving the accuracy of the living-body detection. Then, more effective security verification or attack defense can be implemented based on the detection results.

Each of the above described modules and models may be implemented as software, or hardware, or a combination of software and hardware. For example, each of the above described modules and models may be implemented using a processor executing instructions stored in a memory. Also, for example, each of the above described modules and models may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

The above description is merely example embodiments of this specification and is not intended to limit the protection scope of this specification. Any modification, equivalent replacement, improvement and the like made without departing from the spirit and principle of the embodiments of this specification should be included in the protection scope of this specification.

The system, apparatus, module or unit illustrated in the above embodiments may be implemented by a computer chip or an entity, or by a product having a certain function. A typical implementation device is a computer. For example, the computer may be a personal computer, a laptop computer, a cellular phone, a camera phone, a smart phone, a personal digital assistant, a media player, a navigation device, an email device, a game console, a tablet computer, a wearable device, or a combination of any of these devices.

The computer-readable medium includes non-volatile and volatile media as well as movable and non-movable media and may implement information storage by means of any method or technology. The information may be a computer-readable instruction, a data structure, a module of a program or other data. An example of the storage medium of a computer includes, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and can be used to store information accessible to the computing device. The computer-readable storage medium does not include transitory media, such as a modulated data signal and a carrier.

It should be further noted that the terms “include,” “comprise” or any other variations thereof are intended to cover non-exclusive inclusion, so that a process, method, article or device including a series of elements not only includes the elements, but also includes other elements not expressly listed, or further includes elements inherent to the process, method, article or device. In the absence of more limitations, an element defined by “including a/an . . . ” does not exclude that the process, method, article or device including the element further has other identical elements.

Various embodiments of this specification are described in a progressive manner. The same or similar parts between the embodiments may be referenced to one another. In each embodiment, the part that is different from other embodiments is mainly described. Particularly, the system embodiment is described in a relatively simple manner because it is similar to the method embodiment, and for related parts, reference can be made to the parts described in the method embodiment.

Although the specification has been described in conjunction with specific embodiments, many alternatives, modifications and variations will be apparent to those skilled in the art. Accordingly, the following claims embrace all such alternatives, modifications and variations that fall within the terms of the claims.

1. A three-dimensional living-body face detection method, comprising:
acquiring multiple frames of depth images for a target detection object;
pre-aligning the multiple frames of depth images to obtain pre-processed point cloud data;
normalizing the point cloud data to obtain a grayscale depth image; and
performing living-body detection based on the grayscale depth image and a living-body detection model.

2. The method of claim 1, wherein the pre-processed point cloud data is first pre-processed point cloud data, the grayscale depth image a first grayscale depth image, and the living-body detection model is obtained by:
acquiring multiple frames of depth images for a target training object;
pre-aligning the multiple frames of depth images for the target training object to obtain second pre-processed point cloud data;
normalizing the second point cloud data to obtain a second grayscale depth image sample; and
training based on the second grayscale depth image sample and label data of the second grayscale depth image sample to obtain the living-body detection model.

3. The method of claim 1, wherein the pre-aligning the multiple frames of depth images to obtain pre-processed point cloud data comprises:
roughly aligning the multiple frames of depth images based on three-dimensional key facial points; and
finely aligning the roughly aligned depth images based on an iterative closest point (ICP) algorithm to obtain the point cloud data.

4. The method of claim 1, wherein before pre-aligning the multiple frames of depth images, the method further comprises:
bilaterally filtering each frame of depth image in the multiple frames of depth images.

5. The method of claim 1, wherein the normalizing the point cloud data to obtain a grayscale depth image comprises:
determining an average depth of a face region for the target detection object according to three-dimensional key facial points in the point cloud data;
segmenting the face region and deleting a foreground and a background in the point cloud data; and
normalizing the point cloud data from which the foreground and background have been deleted to preset value ranges before and after the average depth to obtain the grayscale depth image, the preset value ranges taking the average depth as a reference.

6. The method of claim 5, wherein each of the preset value ranges is from 30 mm to 50 mm.

7. The method of claim 2, wherein before the training based on the second grayscale depth image sample to obtain the living-body detection model, the method further comprises:
performing data augmentation on the second grayscale depth image sample, wherein the data augmentation comprises at least one of: a rotation operation, a shift operation, or a zoom operation.

8. The method of claim 1, wherein the living-body detection model is a model obtained by training based on a convolutional neural network structure.

9. The method of claim 1, wherein the multiple frames of depth images are acquired based on an active binocular depth camera.

10. The method of claim 1, further comprising:
determining whether a face authentication recognition succeeds according to a result of the living-body detection.

11. An electronic device, comprising:
a memory storing a computer program; and
a processor, wherein the processor is configured to execute the computer program to:
acquire multiple frames of depth images for a target detection object;
pre-align the multiple frames of depth images to obtain pre-processed point cloud data;
normalize the point cloud data to obtain a grayscale depth image; and
perform living-body detection based on the grayscale depth image and a living-body detection model.

12. The electronic device of claim 11, wherein the pre-processed point cloud data is first pre-processed point cloud data, the grayscale depth image a first grayscale depth image, and the living-body detection model is obtained by:
acquiring multiple frames of depth images for a target training object;
pre-aligning the multiple frames of depth images for the target training object to obtain second pre-processed point cloud data;
normalizing the second point cloud data to obtain a second grayscale depth image sample; and
training based on the second grayscale depth image sample and label data of the second grayscale depth image sample to obtain the living-body detection model.

13. The electronic device of claim 11, wherein the processor is further configured to execute the computer program to:
roughly align the multiple frames of depth images based on three-dimensional key facial points; and
finely align the roughly aligned depth images based on an iterative closest point (ICP) algorithm to obtain the point cloud data.

14. The electronic device of claim 11, wherein before pre-aligning the multiple frames of depth images, the processor is further configured to execute the computer program to:
bilaterally filter each frame of depth image in the multiple frames of depth images.

15. The electronic device of claim 11, wherein the processor is further configured to execute the computer program to:
determine an average depth of a face region for the target detection object according to three-dimensional key facial points in the point cloud data;
segment the face region and delete a foreground and a background in the point cloud data; and
normalize the point cloud data from which the foreground and background have been deleted to preset value ranges before and after the average depth to obtain the grayscale depth image, the preset value ranges taking the average depth as a reference.

16. The electronic device of claim 15, wherein each of the preset value ranges is from 30 mm to 50 mm.

17. The electronic device of claim 12, wherein before the training based on the second grayscale depth image sample to obtain the living-body detection model, the processor is further configured to execute the computer program to:
perform data augmentation on the second grayscale depth image sample, wherein the data augmentation comprises at least one of: a rotation operation, a shift operation, or a zoom operation.

18. The electronic device of claim 11, wherein the living-body detection model is a model obtained by training based on a convolutional neural network structure.

19. The electronic device of claim 11, wherein the multiple frames of depth images are acquired based on an active binocular depth camera.

20. A computer-readable storage medium storing one or more programs, wherein when executed by a processor of a device, the one or more programs cause the device to perform:
acquiring multiple frames of depth images for a target detection object;
pre-aligning the multiple frames of depth images to obtain pre-processed point cloud data;
normalizing the point cloud data to obtain a grayscale depth image; and
performing living-body detection based on the grayscale depth image and a living-body detection model.
